(19) United States
(12) Patent Application Publication
(10) Pub. No.: US 2023/0336027 A1
(43) Pub. Date: Oct. 19, 2023

(54) METHOD FOR DETECTING AN OBJECT TO BE CHARGED AND ASSOCIATED CHARGING DEVICE

(71) Applicant: Continental Automotive Technologies GmbH, Hannover (DE)

(72) Inventors: Joao Carlos Vasconcelos De Almeida, Toulouse (FR); Brahim Aloui, Toulouse (FR); Juvenal Alarcon Ramos, Toulouse (FR)

(21) Appl. No.: 18/028,849

(22) PCT Filed: Jul. 8, 2021
(86) PCT No.: PCT/EP2021/069087

§ 371 Date: Mar. 28, 2023

(30) Foreign Application Priority Data
Oct. 15, 2020 (FR) 2010586

(51) Int. Cl. H02J 50/12; H02J 50/90; B60R 16/03

(52) U.S. Cl. CPC H02J 50/12; B60R 16/03; H02J 50/90

(57) ABSTRACT

A method for detecting an object to be charged, by a charging device, including a transmitting coil and a microcontroller which are suitable for charging a portable item of user equipment at an operating frequency. The method including the following steps: transmitting a predetermined number of voltage pulses at the terminals of the transmitting coil, at a parasitic resonant frequency, contained in a window of values, the resonant frequency being different and distinct from the operating frequency; measuring the voltage at the terminals of the transmitting coil; comparing a frequency of the voltage thus measured and the window of values; if the frequency of the voltage is contained in the window of values, then detecting a portable item of user equipment to be charged.

### CROSS REFERENCE TO RELATED APPLICATIONS

This application is the U.S. National Phase Application of PCT International Application No. PCT/EP2021/069087, filed Jul. 8, 2021, which claims priority to French Patent Application No. 2010586, filed Oct. 15, 2020, the contents of such applications being incorporated by reference herein.

### FIELD OF THE INVENTION

The field of the invention is the field of magnetic induction charging devices. In particular, the invention relates to a method for detecting an object to be charged located close to a magnetic induction electrical charging device and to an associated charging device.

### BACKGROUND OF THE INVENTION

Magnetic induction electrical charging technology is implemented in a system comprising a wireless electrical charging device and an electrical storage battery to be charged in a mobile terminal such as, for example, a portable item of user equipment, such as a mobile telephone. The electrical charging device comprises a transmission coil, or transmitting coil. The electrical storage battery comprises a receiving coil to be charged. When the transmission coil and the receiving coil are located opposite each other, variations in the magnetic field which is generated by the transmission coil cause an electric current to flow in the receiving coil, thereby charging the electrical storage battery.

Inductive charging technology meets the requirements of a standard, in this case it is the Qi® standard of the Wireless Power Consortium, also called the WPC standard.

In order to detect the presence of an electrical storage battery comprising a receiving coil located opposite the transmission coil of the electrical charging device, three steps are currently implemented.

In a first step, the methods of the prior art seek to detect the presence of an object located opposite the electrical charging device. For this purpose, electrical pulses, also called “pings”, are sent at the charging frequency via the transmission coil of the electrical charging device to the receiving coil. A ping is a continuous signal, exhibiting periodic oscillations, with a period of, for example, 300 ms, and with an oscillation time of 5 to 20 ms. The voltage or the impedance at the terminals of the transmission coil is observed. If variation in the voltage at the terminals of the transmission coil or in the impedance of the transmission coil is detected, then there is an object opposite the transmission coil.

The detected object may be either a parasitic object or a mobile apparatus such as a mobile telephone equipped with a receiving coil for inductive electrical charging. In a second step, efforts are then made to establish digital communication with the detected object in order to identify its character. More particularly, efforts are made in this second step to ascertain whether the detected object has a receiving coil for inductive electrical charging in order to charge it. This communication is performed by modulating the amplitude of the voltage of the transmitting coil.

When digital communication is established between the transmission coil and the receiving coil of the detected object, then a third step begins. The third step makes it possible to electrically charge the receiving coil of the detected object.

The drawback of such a detection method is the high power consumption caused during the transmission of pings and also the quantity of harmful radiation close to a human body. This radiation may in certain cases exceed international recommendations on continuous exposure to magnetic fields when the human body is close (within a few centimeters) to a transmitting coil.

Another method known from the prior art is to use the one or more NFC (near-field communication) antennas located in the inductive charger in order to detect the presence of the electrical storage battery. The method consists in transmitting, at a fixed frequency, signals at the frequency of 13.56 MHz; if an electrical storage battery is located close to the NFC antennas, then the impedance and/or the consumption of said NFC antennas varies.

However, this method is not robust, and does not make it possible to detect certain receiving coils of small sizes, and also TPRs, or test power receivers, that is to say electrical storage batteries used during the phase of certifying mobile telephones for the Qi standard.

The aim of the present invention is to overcome all or some of the drawbacks of the prior art, in particular those outlined above, by providing a method for detecting an electrical storage battery of portable user equipment type on the charging surface of an inductive recharging device which makes it possible to detect any type of portable equipment, whatever the size of the receiving coil, and also the power receivers used in the certification tests for the Qi standard.

### SUMMARY OF THE INVENTION

An aspect of the invention relates to a method for detecting an object to be charged, by a charging device, comprising a transmitting coil and a microcontroller which are suitable for charging a portable item of user equipment at an operating frequency, the method being characterized in that it comprises the following steps:
a. transmitting a predetermined number of voltage pulses at the terminals of the transmitting coil, at a parasitic resonant frequency, contained in a window of values, said resonant frequency being different and distinct from the operating frequency,
b. measuring the voltage at the terminals of the transmitting coil,
c. comparing a frequency of the voltage thus measured and said window of values,
d. if the frequency of the voltage is contained in said window of values, then detecting a portable item of user equipment to be charged.

In a first embodiment of the invention, comparing the frequency of the voltage and the window of values comprises comparing the measured voltage and a minimum voltage threshold and a maximum voltage threshold for a predetermined time.

In a second embodiment of the invention, the comparison comprises a frequency analysis by means of a Fourier transform of the voltage.

Preferably, the predetermined number of pulses is equal to three.

An aspect of the invention also relates to a device for charging a portable item of user equipment, comprising a transmitting coil and a microcontroller, which are suitable for charging the portable item of user equipment at an operating frequency, said device being characterized in that it further comprises:
a. means for generating a predetermined number of voltage pulses at the terminals of the transmitting antenna at a parasitic resonant frequency contained in a window of values, which is different and distinct from the operating frequency,
b. means for measuring voltage at the terminals of the transmitting antenna and
c. means for detecting a portable item of user equipment P to be charged depending on a frequency of the voltage at the terminals of the transmitting antenna thus measured.

In the first embodiment of the invention, the detection means comprise means for comparing said voltage and two thresholds, a minimum threshold and a maximum threshold, for a predetermined time.

In a second embodiment of the invention, the detection means comprise means for making Fourier transform frequency calculations of the voltage and for comparing the frequency of said voltage and the window of values.

Advantageously, the generation means, the measurement means and the detection means are contained in a printed circuit.

Preferably, the generation means comprise a switch and a resistor which are connected in series to a voltage source.

An aspect of the invention also relates to any motor vehicle comprising a charging device according to any one of the features listed above.

### BRIEF DESCRIPTION OF THE DRAWINGS

Other features and advantages of aspects of the invention will become more apparent upon reading the following description. This description is purely illustrative and should be read with reference to the appended drawings, in which:

FIG. 1 schematically shows a charging device D of the prior art, above which there is a portable item of user equipment P to be charged,

FIG. 2 schematically shows the means for generating voltage pulses at a parasitic resonant frequency, according to an aspect of the invention,

FIG. 3 schematically shows the charging device D′ according to an aspect of the invention,

FIG. 4A is a graph showing the impedance of the transmitting coil of the charging device as a function of the transmission frequency of the transmitting coil, without a portable item of equipment P placed on the charging surface,

FIG. 4B is a graph showing the impedance of the transmitting coil of the charging device as a function of the transmission frequency of the transmitting coil, with a compatible portable item of equipment P placed above the charging surface,

FIG. 5 is a graph showing the voltage pulses transmitted at the parasitic resonant frequency,

FIG. 6A is a graph showing the voltage at the terminals of the transmitting coil after the transmission of the voltage pulses at the parasitic resonant frequency without a compatible portable item of user equipment located on the charging surface,

FIG. 6B is a graph showing the voltage at the terminals of the transmitting coil after the transmission of the voltage pulses at the parasitic resonant frequency with a compatible portable item of user equipment located on the charging surface,

FIG. 7 is a flowchart showing the various steps of the detection method according to an aspect of the invention,

FIG. 8A is a graph showing the Fourier transform, in dB, of the voltage V_{B1} at the terminals of the transmitting antenna, without a compatible portable item of user equipment placed on the charging surface,

FIG. 8B is a graph showing the Fourier transform, in dB, of the voltage V_{B1} at the terminals of the transmitting antenna, with a compatible portable item of user equipment placed on the charging surface.

### DETAILED DESCRIPTION OF THE PREFERRED EMBODIMENTS

FIG. 1 shows a charging device D of the prior art comprising a transmitting coil B1 and a charging surface S on which a portable item of user equipment P comprising a receiving coil B2 is placed.

The charging device D may be, for example but in an entirely non-limiting manner, intended to be installed in a motor vehicle.

As explained previously, when the transmitting coil B1 and the receiving coil B2 are located opposite each other, variations in the magnetic field which is generated by the transmitting coil B1 cause an electric current to flow in the receiving coil B2, thereby charging the portable item of user equipment P.

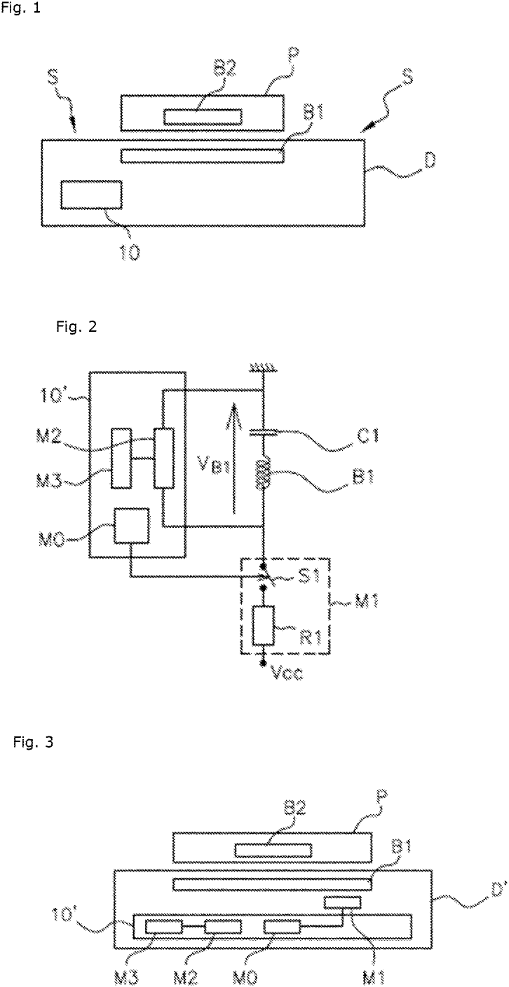

An aspect of the invention provides a charging device D′ illustrated in FIGS. 2 and 3 making it possible to overcome the drawbacks of the prior art.

The device D′ comprises a printed circuit 10′ equipped with a microcontroller connected to the transmitting coil B1 and also to an impedance-matching capacitor C1. The microcontroller 10 is suitable for managing the transmission and the reception of data via the transmitting antenna B1 at an operating frequency F_{RF}. Said operating frequency F_{RF} is the frequency used to charge the portable item of user equipment P according to the Qi standard of the WPC® (Wireless Power Consortium), and is between 90 kHz and 205 kHz. To this end, the microcontroller comprises hardware and software means suitable for managing the transmission and the reception of data and also the control of the operation of the transmitting antenna B1. This is known in the prior art and will not be described in more detail here.

According to an aspect of the invention, the charging device D′ also comprises:
a. means M1 for generating a predetermined number of voltage pulses at the terminals of the transmitting antenna B1 at a parasitic resonant frequency F_{RP} which is, for example, contained in a window between 900 kHz and 1.1 MHz, said pulses being in the form of square-wave signals with a period of between 0.83 µs and 1.25 µs.
b. means M2 for measuring voltage at the terminals of the transmitting antenna B1 and
c. means M3 for detecting a portable item of user equipment P to be charged depending on the analysis of a frequency of the voltage F_{B1} at the terminals of the transmitting antenna B1.

The voltage pulse transmission or generation means M1 are illustrated in FIG. 2 and are, for example, in the form:
a. of a switch S1 connected to a branch of the transmitting antenna B1,
b. of a resistor R1, connected in series to said switch S1, and itself connected to a voltage source Vcc,
c. of the means M0 for controlling said switch S1, in order to open or to close said switch, said control means M0 being, for example, in software form.

The voltage pulse generation means M1 is a generator of voltage signals in the form of square waves.

By controlling the opening and the closing of the switch S1, which is connected to the voltage source Vcc, voltage pulses are generated at the terminals of the transmitting antenna B1. This is illustrated in FIG. 5. FIG. 5 shows three voltage pulses in the form of square waves.

The means M2 for measuring the voltage V_{B1} at the terminals of the transmitting antenna B1 are, for example, in software form.

The means M3 for detecting the presence of a compatible portable item of user equipment P on the charging surface S are in the form of means for analyzing and processing the voltage V_{B1} at the terminals of the transmitting antenna B1.

The pulse generation means M1, the voltage measurement means M2 and the detection means M3 may be contained in a printed circuit 10′, either in the form of discrete components with a microcontroller or in the form of an ASIC (application-specific integrated circuit).

In a first embodiment, said detection means M3 may comprise means for comparing the voltage V_{B1} at the terminals of the transmitting antenna with two threshold voltages, a minimum voltage V- and a maximum voltage V+, for a predetermined time Δt. Said comparison means are, for example, in software form.

In a second embodiment, said detection means M3 may comprise means for making frequency calculations, such as a Fourier transform operation on the voltage V_{B1} at the terminals of the transmitting antenna B1, in order to determine the oscillation frequency of the voltage F_{B1} at the terminals of the transmitting antenna B1 and for comparing the frequency thus determined and the window of parasitic resonant frequencies F_{RP}, as is described in detail below.

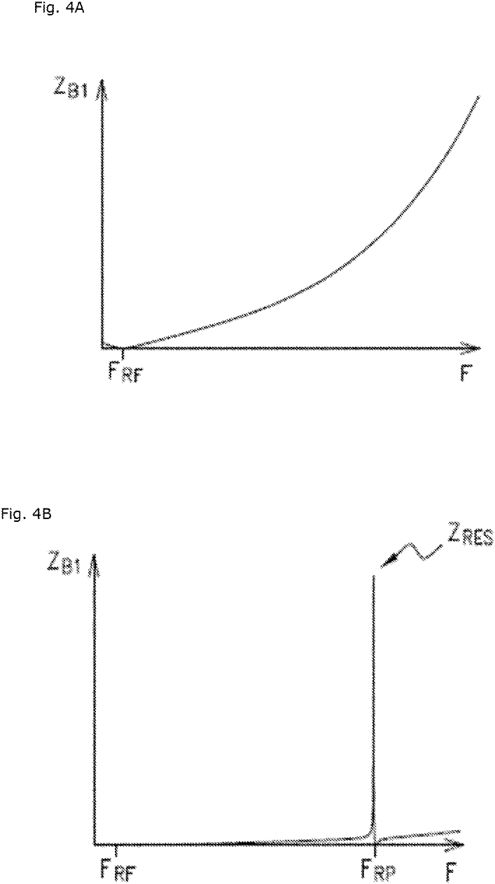

An aspect of the invention is based on the fact that all receivers which are compatible with the Qi standard, that is to say all portable items of user equipment P and also TPRs which are compatible with the WPC inductive recharging standard, have or possess an intrinsic parasitic resonant frequency F_{RP} of between 900 kHz and 1.1 MHz, or around 1000 kHz with a tolerance of +/-10%. This is illustrated in FIGS. 4A and 4B. FIG. 4A shows the impedance Z_{B1} of the transmitting coil B1 as a function of the transmission frequency F of the transmitting coil B1, without the presence of a compatible portable item of equipment P on the charging surface S. The operating frequency F_{RF} is the transmission frequency of electromagnetic waves from the transmitting coil B1. FIG. 4B shows the impedance Z_{B1} of the transmitting coil B1 as a function of the transmission frequency F, in the presence of a compatible portable item of user equipment P on the charging surface S; a high impedance Z_{RES} is apparent therein, at a parasitic resonant frequency FRP which is different and distinct from the operating frequency F_{RF}.

By stimulating said receivers P at their parasitic resonant frequency F_{RP}, the phenomenon of parasitic resonance causes the impedance of the transmitting coil B1, which is coupled to the receiver (portable item of equipment), to be modified, and said electromagnetic coupling also causes oscillations in the voltage V_{B1} at the terminals of said transmitting coil B1 at said parasitic resonant frequency F_{RP} for a predetermined time Δt. This will be explained below.

The detection method according to an aspect of the invention will now be described in light of the flowchart illustrated in FIG. 7.

In the initial step E1, voltage pulses, for example a predetermined number N, for example N = 3, three successive voltage pulses P1, are generated at the terminals of the transmitting coil B1 and transmitted at a parasitic resonant frequency F_{RP}, that is to say contained in a window of values between 900 kHz and 1.1 MHz with a tolerance of +/-10%, or between about 800 kHz and 1.2 MHz. These voltage pulses generate electromagnetic waves at the parasitic resonant frequency F_{RP} destined for the transmitting coil B1. Said pulses have a period of between 0.83 µs and 1.25 µs.

Said parasitic resonant frequency F_{RP} is between 900 kHz and 1.1 MHz and is distinct from the operating frequency F_{RF}, according to the WPC Qi standard, which for its part is between 90 kHz and 205 kHz.

Said receiving coil B2 then receives an electromagnetic field at its parasitic resonant frequency F_{RP} originating from the transmitting coil B1.

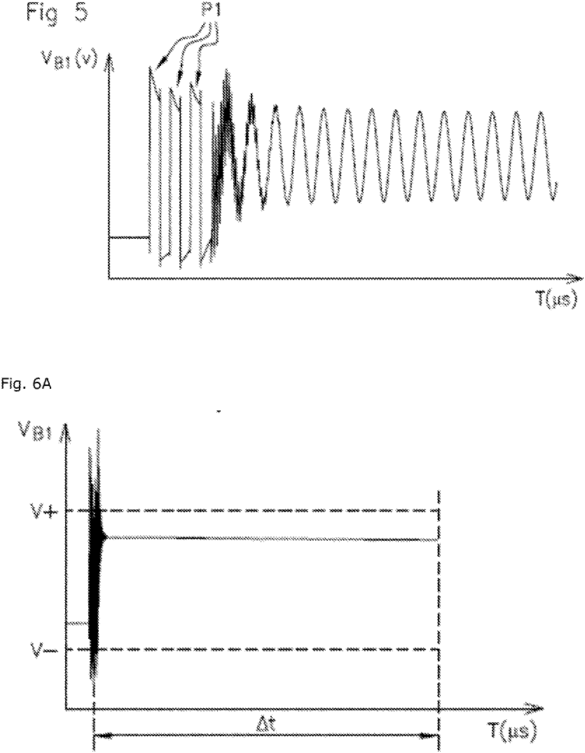

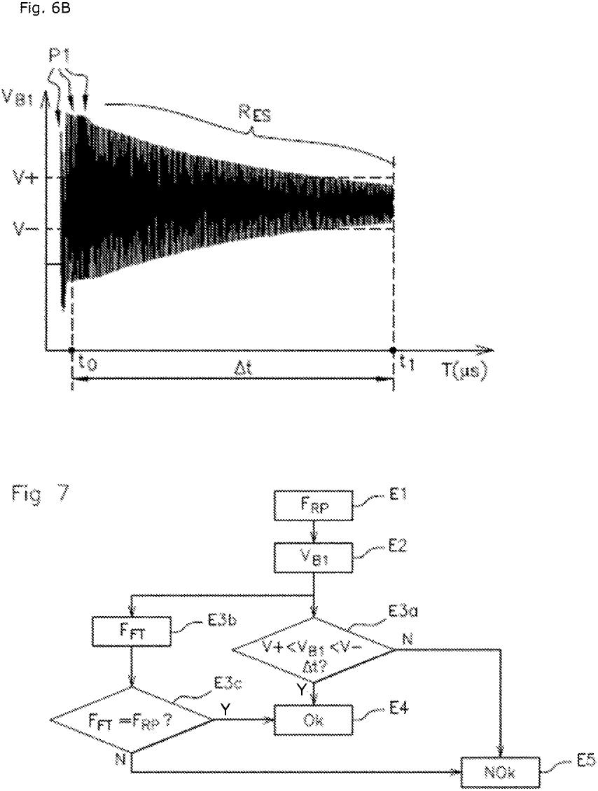

Said receiving coil B2 is thus electromagnetically coupled with the transmitting coil B1, at said parasitic resonant frequency F_{RP}. This phenomenon of resonance causes oscillations in the voltage V_{B1} at the terminals of the transmitting coil B1, which follow the voltage pulses transmitted initially. This is illustrated in FIGS. 6A and 6B.

If there is no portable item of user equipment P or TPR on the bearing surface S, then no electromagnetic coupling between the two coils B1, B2 occurs.

Likewise, if an object, or a portable item of user equipment which is incompatible with the Qi charging standard, is on the bearing surface S, no coupling at the parasitic resonant frequency F_{RP} will occur between the two said coils B1, B2.

In the second step E2, the voltage V_{B1} at the terminals of the transmitting coil B1 is measured and it is checked that the two coils, the transmitting coil B1 and the receiving coil B2, are electromagnetically coupled at a frequency contained in the window of the parasitic resonant frequency F_{RP}.

The oscillations in voltage V_{B1} are then analyzed in order to check that said oscillations have a frequency FB1 contained in the parasitic frequency window.

In a first embodiment, in the step E3a, a time analysis of the voltage signal V_{B1} is performed, that is to say that the voltage V_{B1} thus measured is compared with two predetermined voltage thresholds, a maximum threshold V+ and a minimum threshold V-for a predetermined time Δt.

If the measured voltage V_{B1} oscillates alternately between a value which is above the maximum threshold V+ and a value which is below the minimum threshold V- for a predetermined time Δt, this means that the coils are electromagnetically coupled at the parasitic resonant frequency F_{RP} and that a portable item of user equipment P or a TPR which is compatible with the Qi/WPC standard is located on the charging surface S of the charging device D (step E4) and that inductive charging may begin.

Otherwise, if the measured voltage V_{B1} is neither above the maximum threshold V+ nor below the minimum threshold V- for a predetermined time Δt, then this means that no portable item of user equipment P or TPR which is Qi-/WPC-compatible is located on the charging surface S of the charging device D (step E5), and no charging occurs.

This is shown in FIGS. 6A and 6B. FIG. 6A shows the voltage V_{B1} at the terminals of the transmitting coil B1 as a function of time, without a compatible portable item of equipment P or TPR located on the charging surface S. After the predetermined number N of voltage pulses P1, the voltage at the terminals of the transmitting antenna V_{B1} is stable, does not oscillate and is between the minimum threshold V- and the maximum threshold V+.

FIG. 6B shows the voltage V_{B1} at the terminals of the transmitting coil B1 as a function of time, with a compatible portable item of equipment P or a compatible TPR located on the charging surface S. After the predetermined number of voltage pulses P, the voltage at the terminals of the transmitting antenna V_{B1} is, for a predetermined time, above the maximum threshold V+ and below the minimum threshold V-.

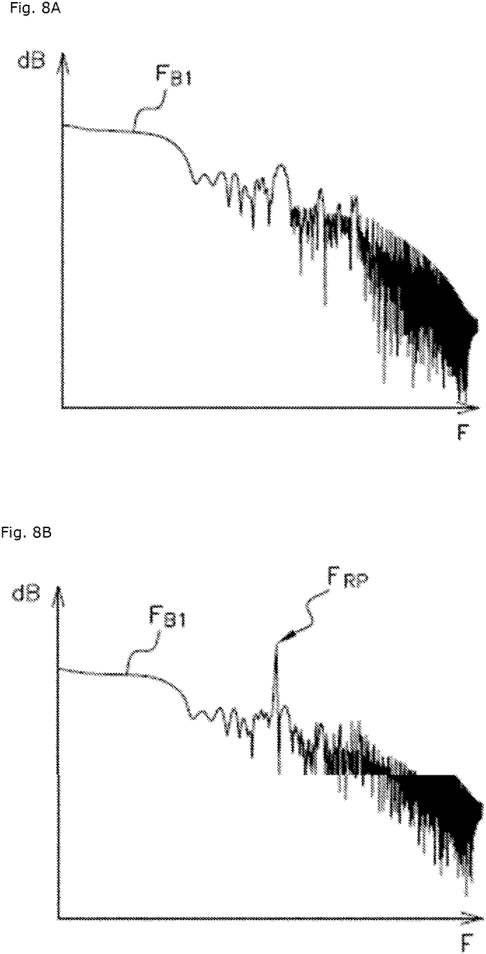

In a second embodiment, a frequency analysis of the voltage V_{B1} is performed, that is to say that, in the step E3b, the Fourier transform of the voltage F_{B1} at the terminals of the transmitting coil B1 is carried out, in order to determine the frequency of the voltage F_{B1}, after the pulses have been transmitted, and to determine the value thereof. If there is a peak in the measured frequency F_{B1} (step E3c) which is substantially equal to the parasitic resonant frequency F_{RP}, or between 900 kHz and 1.1 MHz (to which a tolerance of +/-10% may be added), then this means that the coils are electromagnetically coupled at the parasitic resonant frequency F_{RP} and that a portable item of user equipment P or a TPR which is compatible with the Qi/WPC standard is located on the charging surface S of the charging device D (step E4) and that inductive charging may begin. This is illustrated in FIG. 8B, which shows the Fourier transform of the voltage V_{B1}; a frequency peak which is located at 1 MHz and which therefore corresponds to the window of the parasitic resonant frequency F_{RP} is apparent.

Following the Fourier transform (step E3b), if the frequency peak of the voltage F_{B1} is not between 800 kHz and 1 MHz (step E3c), or if no frequency peak is apparent in the parasitic resonance window F_{RP}, then this means that no portable item of user equipment P or TPR which is Qi-/WPC-compatible is located on the charging surface S of the charging device D. This is illustrated in FIG. 8A, which shows the Fourier transform of the voltage V_{B1}; no frequency peak is apparent.

Of course, these two embodiments are in no way limiting; any calculation method making it possible to check that the voltage V_{B1} at the terminals of the transmitting antenna B1 continues to oscillate in the window of the parasitic resonant frequency F_{RP}, and to do so after the predetermined number N of pulses at said frequency F_{RP} have been transmitted, is contained in the detection method according to an aspect of the invention.

An aspect of the invention therefore ingeniously makes it possible to use the parasitic resonant frequency F_{RP} existing in all receivers which are compatible with the Qi standard, in order to detect their presence on the charging surface of a charging device D′. An aspect of the invention is particularly easy to implement as it needs only pulse generation means (for example, in the form of two switches and one resistor), means for controlling these said generation means and means for determining the presence of a compatible item of equipment by means of time or frequency analysis of the voltage at the terminals of the transmitting antenna.

1. A method for detecting an object to be charged, by a charging device, comprising a transmitting coil and a microcontroller which are suitable for charging a portable item of user equipment (P) at an operating frequency, the method comprising:
a) transmitting a predetermined number of voltage pulses at the terminals of the transmitting coil, at a parasitic resonant frequency, between 800 kHz and 1.2 MHz, said resonant frequency being different and distinct from the operating frequency,
b) measuring the voltage at the terminals of the transmitting coil,
c) comparing a frequency of the voltage thus measured and said window of values, and
d) if the frequency of the voltage is contained in said window of values, then detecting a portable item of user equipment to be charged by the transmitting coil .

2. The detection method as claimed in claim 1, wherein comparing the frequency of the voltage and the window of values comprises comparing the measured voltage and a minimum voltage threshold and a maximum voltage threshold for a predetermined time.

3. The detection method as claimed in claim 1, wherein the comparison comprises a frequency analysis by means of a Fourier transform of the voltage.

4. The detection method as claimed in claim 1, wherein the predetermined number is equal to three.

5. A device for charging a portable item of user equipment, comprising:
a transmitting coil and a microcontroller, which are suitable for charging the portable item of user equipment at an operating frequency
means for generating a predetermined number of voltage pulses at the terminals of the transmitting antenna at a parasitic resonant frequency between 800 kHz and 1.2 MHz, which is different and distinct from the operating frequency,
means for measuring voltage at the terminals of the transmitting antenna and
means for detecting a portable item of user equipment to be charged by the transmitting coil depending on a frequency of the voltage at the terminals of the transmitting antenna thus measured.

6. The charging device as claimed in claim 5, wherein the detection means comprise means for comparing said voltage and two thresholds, a minimum threshold and a maximum threshold, for a predetermined time.

7. The charging device as claimed in claim 5, wherein the detection means comprise means for making Fourier transform frequency calculations of the voltage and for comparing the frequency of said voltage and the window of values.

8. The charging device as claimed in claim 5, wherein the generation means, the measurement means and the detection means are contained in a printed circuit.

9. The charging device as claimed in claim 5, wherein the generation means comprise a switch and a resistor which are connected in series to a voltage source.

10. A motor vehicle, comprising a charging device as claimed in claim 5.
